(19) United States
(12) Patent Application Publication
(10) Pub. No.: US 2026/0328045 A1
(43) Pub. Date: Oct. 22, 2026

(54) TRANSLUCENT ENCLOSING FRAMELESS STRUCTURE BASED ON HIGH-STRENGTH DOUBLE-GLAZED WINDOWS WITH LOW OPTICAL DISTORTIONS

(71) Applicant: AESTECH INC., Inglewood, CA (US)

(72) Inventors: Leonid LAZEBNIKOV, Los Angeles, CA (US); Ihor SHCHEDRIN, Kyiv (UA)

(21) Appl. No.: 19/112,187

(22) PCT Filed: Sep. 13, 2023
(86) PCT No.: PCT/US2023/032612

§ 371 Date: Mar. 14, 2025

Related U.S. Application Data
(60) Provisional application No. 63/406,948, filed on Sep. 15, 2022.

(51) Int. Cl. E06B 3/02; C03C 27/00; E06B 3/663

(52) U.S. Cl. CPC E06B 3/025; C03C 27/00; E06B 3/66314; E06B 3/66333

(57) ABSTRACT

The present invention describes a novel frameless double-glazed window unit assembly having a lightweight, rigid enclosing structure. The window unit comprises two or more glass sheets that are hermetically sealed and fixed relative to each other by way of a composite spacer with a rigid profile providing a distance between glass sheets. The composite spacer with the rigid profile has an internal reinforcement cross-section having a high reduced modulus of elasticity. The composite spacer works together with a highly adhesive layer to increase the stiffness of each unit and the strength of the overall window unit. The novel assembly helps reduce and prevent lensing distortions or deformations found in traditional double-glazed window structures. The inventive assembly is stackable and does not require any kind of structural framing found in traditional double-glazed window structures. The inventive assembly can be optimized to meet structural requirements and compliance for any architectural and construction solution.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to double-glazed window units having elements such as a glass window or glass facade for frameless window construction having an improved resistance to drastic temperature changes and heavy wind loads.

### BACKGROUND OF THE INVENTION

Most modern office and residential buildings feature double-glazed window unit assemblies that are designed to withstand temperature changes and a multitude of forces acting on a building. Typical buildings are exposed to shear, tension, torsion and compression forces. Wind can place a serious load on a building from any direction with the resulting force that is pushing the building resisted by shear walls. Earthquakes are quite a different story with not only shear walls required for lateral movement but the compression and tension caused by ground acceleration vertically highly significant and causing structure to fail.

Conventional double-glazed window structures are generally tightly affixed inside the surrounding metal frames, which are usually made of aluminum. Aluminum is preferred as a frame material because it doesn't corrode and is lightweight. These frames can support much bigger panes of glass than, for instance, wood or plastic frames can, all while still retaining a small profile. Because aluminum frames can support a lot bigger glass panes using smaller window frames, viewers can admire wider views, and enjoy more light inside the unit.

More recently, frameless window technology has become much more desirable for applications in newer building structures, and in complex building designs. Frameless technology is preferred for such installations because framing is not an attractive option. And frameless windows provide generous dimensions, allow a lot more light and offer better views, and have a snug, flush-to-floor fit for a clean, modern look. The advent of frameless window technology has enabled architects and builders to create new, sometimes radically different building designs.

But, while frameless technology is more desirable, existing frameless window systems still have significant limitations compared to using aluminum frames. By removing the metal framing, new installations require much thicker, considerably heavier, and as a result much more expensive window assemblies. There are significant limitations to the sizes of the glass that can be used in frameless window assemblies, and there are significant restrictions on the height of the glazing fragment.

There exists no convenient way to affix the frameless window units and stack the units to form a glass wall without losing the clean, sleek look. Each double-glazed window assembly becomes too heavy and could make the entire construction project untenable. For these reasons, most new construction projects still utilize aluminum frames, especially when building much taller structures, which is more expensive, and it limits the ability to be creative with newer building designs.

Over time, all conventional double-glazed window assemblies develop structural problems. When exposed to ever-changing climatic loads, depending on weather and wind conditions, the outside glass pane in the assembly experiences various levels of continuous stresses and changing temperatures. The dried air and/or inert gas that fills the chamber or cavity between the two panes of glass in a double-glazed window is continuously heated and cooled, forcing the gas to expand and contract pushing and pulling both the outside and the inside glass panes into forming a concave and/or convex shape, and causes wear of the sealant holding the structure and leak taking on more air and moisture which may cause the seal to break further loosening the glass panes.

Once the double-glazed window assembly loses its hermetic seal, the loose panes of glass start to move much more freely causing concave and convex lensing distortions in the windows, which become visible to the naked eye. This further causes the double-glazed window assemblies to undergo structural damage negatively impacting the key characteristics such as rigidity, strength, thermal properties, optical quality and appearance.

The effect of “lensing” or “lensing distortion,” or in some cases “collapsing” (i.e. where the glass sheets come into contact with each other) of the insulating glass is directly related to the climatic (e.g. temperature and wind) loads on the glass. These loads can be understood as an increase or decrease in the gas pressure in the insulating glass unit compared to the initial pressure (when the glass assembly was made). The changes in the gas pressure in the insulating glass unit are associated with the changes in the ambient temperature, changes in pressure relative to height, and fluctuations in atmospheric pressure.

During the production of double-glazed window assemblies, the cavity between the glass panes can be filled with dry air or inert gases such as argon, krypton, or mixtures thereof, as is well known, or it can be partially evacuated, insulating the environment between the glass panes. The volume of gas or dry air tends to change all the time after the installation, resulting in increased or decreased loads inside the chamber between the glass panes, which leads to deforming the glass.

The greatest deformations of glass, as a rule, cause changes in the temperature of the outside air, especially when the dried air or inert gas inside the sealed chamber is heated. The heating causes the internal pressure to build, wherein the gas inside the chamber between the panes expands, thereby increasing the internal pressure and forces the panes to distort. Once the gases cool, the pane(s) take on a concave shape. The internal pressure decreases further, forcing the pane to shrink, and causing it to distort even further and sometimes the panes collapse causing leakages in the chamber between the panes.

In order to prevent collapsing of the panes in a conventional double-glazed window, the glass panes are interconnected by a spacer attached to the glass with a non-hardening sealant, and a metal frame, all of which are designed to improve resistance to heavy loads and provide stability of the overall structure of the double-glazed assembly when used in a building.

Most double-glazed metal frames may include a hollow profile that is typically filled with multiple pieces of reinforcing material, such as aluminum or steel extrusion, to stiffen the frame and prevent sealant rupture and gas leakage. The pieces of reinforcing material, however, are typically separate and the frame may still flex substantially at the corners of the frame.

As a result, many existing methods of reinforcement use thick pieces of reinforcing material which may be less energy efficient. It would be desirable to provide a method for reinforcing a window or window sash frame that uses a novel reinforcement structure that may reduce the frame profile and increase stiffness in the corners of the frame without increasing the weight of the overall structure.

The new construction projects are much more resource intensive and significantly more expensive, requiring bigger, heavier windows. And it is much more complicated to reinforce the overall building structure against heavy loads, which require bigger and heavier metal framing to protect the windows against heavy environmental loads.

### SUMMARY OF THE INVENTION

There exists a need for frameless, rigid, low optical distortion double-glazed window assemblies that are stronger and more energy-efficient than conventional double-glazed window assemblies. The frameless double-glazed window assembly must be inexpensive, lightweight, it must remain rigid and retain strong structural form against environmental wear, and to provide a longer serviceable life than a conventional assembly. It must meet engineering and structural requirements to be stackable without using any frames.

Moreover, the frameless assembly must be weight bearing which could be used as a wall structure, while providing improved resistance to massive temperature changes, and wind forces a building may experience. It must prevent or minimize lens distortion: where the maximum displacement in the center of the glass does not exceed 1/350 on the long side of the glass, and does not exceed 1/250 on the short side of the glass. More preferably, it would not exceed 1/700 on the long side of the glass and would not exceed 1/500 on the short side of the glass, and even more preferably less than 1/1000 on the long side of the glass and less than 1/750 on the short side of the glass.

In order to reduce or prevent the collapsing or bulging of the glass panes that leads to weakening of the window unit structure and further leads to optical distortions in double-glazed windows, a novel composite spacer with a rigid profile and a specialized adhesive to affix it to the glass was developed. When the composite spacer and the adhesive are properly affixed in the chamber between the panes of glass (as shown in FIG. 3), it enables the structure to stiffen and strengthen to the double-glazed. When the reduced modulus of elasticity of the composite spacer and the adhesive combined is E=40×10⁶ N/m² or more, high rigidity acts to reduce the level of optical distortions that lead to seals breaking and leaking of the gas between the glass panes, and subsequent bulging and collapsing of the glass panes, and wherein the optimal value should be considered expressed by the following formula: E=200×10⁶ to 1,000×10⁶ N/m².

To obtain a double-glazed window with a low optical distortion according to the present invention, the glass panes were interconnected by the composite spacer having an internal reinforcing cross-section structure as shown in FIG. 3. The internal reinforcing cross-section of the composite spacer with rigid profile can be square, rectangular, oval, round, trapezoidal, or tubular resulting in required properties within the entire structure.

Wherein the material composition for the composite spacer having a rigid plastic profile can be provided in many different forms, such as glass fiber filled thermoplastic extrusions, glass fiber pultrusions, glass fiber thermoplastic extrusions reinforced with thermoplastic pultruded strips, oriented thermoplastic extrusions, and structural thermoplastic foam extrusions. Whichever materials are used in these rigid plastic profiles, they should have an equivalent modulus of elasticity to that of double-glazed glass and the specialized adhesive in order to obtain a composite spacer having a combined reduced modulus of elasticity.

We found that when the reduced modulus of elasticity of the composite spacer with rigid profile is increased inside of a specific range of between E=40×10⁶ N/m² and no more than 9,000×10⁶ N/m² it significantly reduces glass lensing deformations without having to add aluminum bracketing, crossbars or racks, or having any type of hinged fastening used in conventional double-glazed window units.

Moreover, we've discovered that when the reduced modulus of elasticity is increased, under the influence of both positive and negative pressures built up in the double-glazed window, highly concentrated stresses move from the corners of the double-glazed assembly to its sides with a simultaneous increase in the stress distribution area, and therefore, the stresses decrease proportionally as shown in FIG. 5 improving overall structure of the assembly.

According to one aspect of the present invention, in order to ensure an adequate increase in the rigidity, strength, wind loads and bearing capacity of the double-glazed window unit structure it is important to improve the overall stiffness of the double-glazed unit while reducing the stresses concentrated in the corners of the double-glazed window.

Both the improvement of the stiffness or rigidity and the reduction of the stresses in the corners at the edges of the double-glazed window assembly are controlled by optimizing the mechanical properties of the internal reinforcing cross-section of the composite spacer.

According to another aspect of the present invention, it is desirable to reduce the stresses of the corner edges in the double-glazed window in order to increase the bearing capacity by optimizing the physical and mechanical properties of the highly adhesive sealant used to affix the inventive composite spacer with rigid profile inside the chamber between the two glass panes.

In one embodiment, the highly adhesive sealant must exhibit the following physical and mechanical characteristics:
a) Reduced modulus of elasticity E of the composite spacer with rigid profile is 4.0×10⁷ N/m² or more.
b) Reduced modulus of elasticity E of the composite spacer with rigid profile is 9.0×10⁹ N/m² or less.
c) Adhesive Tensile Strength of more than 1.5×10⁶ N/m².
d) A Poisson's coefficient ratio of 0.2-0.4.

The inventive double-glazed window units can be further provided either with a coating of a durable transparent polymer film on one side, or they can be formed by adhering a durable transparent polymer film to a surface of the panes to achieve a desired function, such as, insulating film, glare reducing film, UV blocking coating, privacy film, decorative coating, safety and security coating, and metal and ceramic coatings to block heat and/or light.

UV blocking coatings are one of the most common types of coatings and can block up to 99.9% of UV rays and up to 80% of solar heat entering a home. Spectrally selective UV blocking coatings can vary the amount of light entering a home in addition to UV and solar heat. UV blocking coatings are selected from the group consisting of: Low (Emissivity) E1, Low E2, Low E3, and Low ERS.

The coating or film can be applied to the panes either before or after they are conformed to the size required for the mounting space. The first pane is then mounted in the mounting space with the film-covered surface of the pane facing the sealing surface of the integral spacer, and the second pane, also with a film covering, is then mounted in the mounting space to form a double-pane impact resistant window.

Additionally, the glass panes may be coated with spectrally selective window coatings, designed for hot climates with large amounts of solar radiation, work by selectively filtering out frequencies of light that produce heat while minimizing the loss of visible light transmission.

### BRIEF DESCRIPTION OF THE DRAWINGS

The present embodiments are illustrated by way of example and are not intended to be limited by the figures of the accompanying drawings.

FIG. 1 depicts a diagram of the deformation of conventional single-chamber double-glazed windows.

FIG. 2 depicts a diagram of the deformation of conventional double-chamber double-glazed windows.

FIG. 3 depicts a cross-section of a single-chamber double-glazed window assembly unit comprising the inventive composite spacer with the rigid profile according to the preferred embodiment of the invention.

FIG. 4 depicts the Von Mises equivalent stresses on a simulated double-glazed windowpane of the prior art under a 400 Pa load showing a distribution of regions of high and low stresses.

FIG. 5 depicts a simplified view of FIG. 4 showing a distribution of stresses in a double-glazed window depending on the stiffness of the conventional distance frame.

FIG. 6a depicts the equivalent stresses according to the von Mises test of strength at a load of 400 Pa on an insulating glass unit having the novel composite spacer with rigid profile according to the instant invention exhibiting a reduced modulus of elasticity of 4.0×10⁷ N/m².

FIG. 6b depicts the equivalent stresses according to the von Mises test of strength at a load of 400 Pa on an insulating glass unit having the novel composite spacer with rigid profile according to the instant invention exhibiting a reduced modulus of elasticity of 1.0×10⁸ N/m².

FIG. 6c depicts the equivalent stresses according to the von Mises test of strength at a load of 400 Pa on an insulating glass unit having the novel composite spacer with rigid profile according to the instant invention exhibiting a reduced modulus of elasticity of 2.5×10⁸ N/m².

FIG. 6d depicts the equivalent stresses according to the von Mises test of strength at a load of 400 Pa on an insulating glass unit having the novel composite spacer with rigid profile according to the instant invention exhibiting a reduced modulus of elasticity of 5.0×10⁸ N/m².

FIG. 6e depicts the equivalent stresses according to the von Mises test of strength at a load of 400 Pa on an insulating glass unit having the novel composite spacer with rigid profile according to the instant invention exhibiting a reduced modulus of elasticity of 1.0×10⁹ N/m².

FIGS. 7a-7b depict simplified views of FIGS. 6a-e showing shifted distribution of stresses in a double-glazed window according to the instant invention.

FIGS. 8a-b are graphs showing the change in strength and stiffness of an insulating glass unit as a function of the modulus of elasticity of the composite spacer.

### OBJECTIVES OF THE INVENTION

It is the objective of the present invention to provide a double-glazed glass unit comprising a double-glazed unit having high stiffness provided by composite spacer with rigid profiles, wherein the double-glazed unit further exhibits very low optical distortion, low deformation or lensing, high strength, an increased bearing capacity, and an increased stiffness in the overall structure.

It is the objective of the present invention to provide a double-glazed glass unit having two or more panes of glass, wherein the double-glazed unit exhibits a very high durability that allows no penetration of gases, water vapor and water between the panes.

It is the objective of the present invention to provide a double-glazed glass unit having two or more panes of glass, wherein the double-glazed unit exhibits a high durability that enables a useful life of up to 40 years of operation without deviations from the original form.

It is the objective of the present invention to provide a double-glazed glass unit having two or more panes of glass, wherein the composite spacer with rigid profile in the double-glazed unit exhibits high reduced modulus of elasticity of composite spacer of at least 40×10⁶ N/m² and no more than 9,000×10⁶ N/m².

It is the objective of the present invention to provide a double-glazed glass unit having two or more panes of glass, wherein the composite spacer with rigid profile in the double-glazed unit exhibits high reduced modulus of elasticity of composite spacer of at least 200×10⁶ N/m² to 1,000×10⁶ N/m².

It is the objective of the present invention to provide a double-glazed glass unit for a double-glazed window having two or more panes of glass, wherein the composite spacer with rigid profile is resistant to adhesion to silicone seals.

It is the objective of the present invention is to provide an insulating glass unit that is lighter than a standard insulating glass unit under the same operating conditions.

It is the objective of the present invention to provide a double-glazed glass unit that does not require any aluminum framing or mullion-transom reinforcement.

It is the objective of the present invention to provide a double-glazed glass unit having two or more panes of glass, wherein the composite spacer with rigid profile exhibits thermal conductivity of at least 0.4 W/(m °C).

It is the objective of the present invention to provide an insulating glass unit with two or more sheets of glass, while the insulating glass unit exhibits high resistance to heat up to 120 °C and relative humidity up to 100%.

It is the objective of the present invention to provide a double-glazed glass unit having two or more panes of glass, wherein the double-glazed unit exhibits a high resistance to cold temperatures as low as −50 °C.

It is the objective of the present invention is to provide an insulating glass unit with two or more sheets of glass, while the insulating glass unit exhibits high resistance to ultraviolet radiation in the range of 280-400 nm, having an intensity of 80 W/m² at temperatures up to 50 °C.

It is the objective of the present invention to provide an insulating glass unit with two or more sheets of glass, while the insulating glass unit exhibits resistance to salt solutions, such as, for example, 3% NaCl aqueous solution, at a solution temperature of 20 °C.

It is the objective of the present invention to provide an insulating glass unit with two or more sheets of glass, while the insulating glass unit exhibits resistance to alkaline solutions, such as, for example, a 3% aqueous solution of NaHCO₃, at a temperature of 20 °C.

It is the objective of the present invention to provide an insulating glass unit with two or more sheets of glass, while the insulating glass unit is resistant to alkaline solutions, such as, for example, a 3% aqueous solution of H₂SO₄, at a temperature of 20 °C.

It is the objective of the present invention to provide a double-glazed glass unit having two or more panes of glass, wherein the double-glazed unit has no toxic substances.

It is the objective of the present invention is to provide an insulating glass unit with two or more sheets of glass, wherein the insulating glass unit exhibits chemical resistance to oxygen and ozone.

It is the objective of the present invention to provide a double-glazed glass unit having two or more panes of glass, wherein the double-glazed unit exhibits high tolerance of to infrared radiation.

It is the objective of the present invention to provide a double-glazed glass unit having two or more panes of glass, wherein the double-glazed unit exhibits high resistance to macro- and microbiological exposure, for example insects or fungi.

### DETAILED DESCRIPTION OF THE PREFERRED EMBODIMENTS

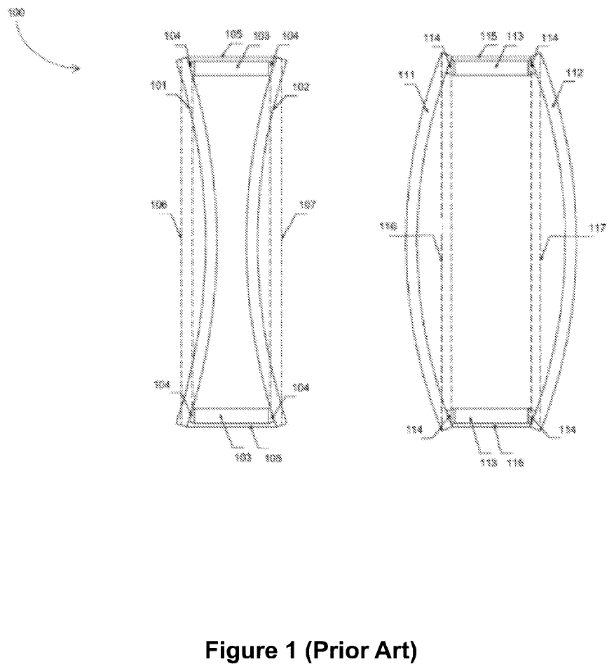

FIG. 1 depicts a conventional double-glazed window unit assembly represented by (100a) and (100b), they are deformed after being exposed to hotter or cooler temperatures.

A conventional double-glazed window assembly (as shown in FIG. 1) comprises a single-chamber double-glazed window having two panes of glass (glass panes shown by the dashed lines 106, 107, 116, and 117). The window units contain a spacer frame (103, as shown in the figure on the left) and (113, as shown in the figure on the right), and it can be up to 7 mm thick. It has a perforation on the plane facing the inter-glass space filled with an inert gas inside the chamber, and it contains a moisture-absorbing molecular sieve.

The spacer (103, 113) (see FIG. 1) is designed to seal the chamber and shape the glass unit. The spacer frame is glued to each pane (106, 107) in the left drawing and (116, 117) in the right drawing using primary seal adhesive, e.g. a butyl sealant (104) in the left figure and (114) in the right figure forming a sealant layer, wherein the thickness of the butyl sealant layer is no more than 0.25 mm on each side. In the primary adhesion, the primary sealant adhesive is applied to the spacer frame at around the perimeter of the double-glazed window where it touches the spacer.

To completely seal the chamber between the two panes in the double-glazed window, a secondary adhesion using a common hardening sealant is made (105, as shown in the figure on the left) and (115, as shown in the figure on the right). Glue or a well-known adhesive is applied as the secondary sealant at the ends of the double-glazed window along the parameter of the top and bottom edges of the double-glazed window forming a secondary sealant layer. The thickness of the secondary sealant layer is at least 4 mm.

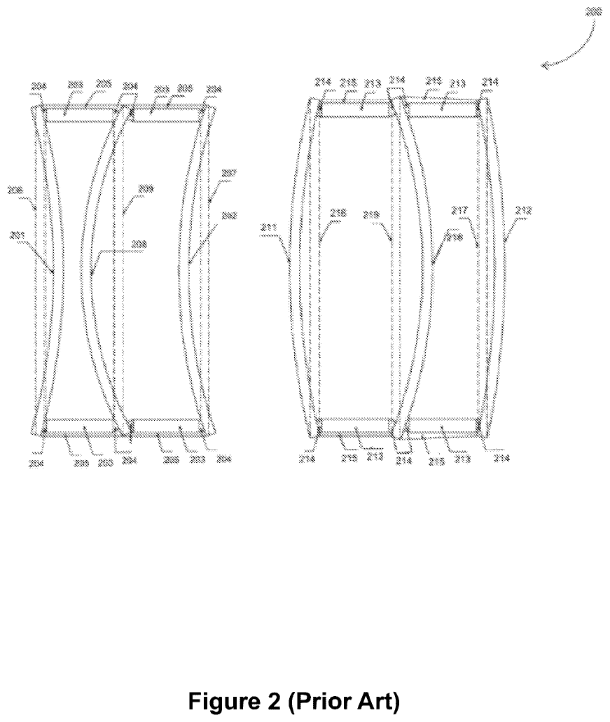

Similarly, FIG. 2 is another depiction of the prior art, the window unit comprises a double-chamber window having three panes of glass (glass panes shown by the dashed lines 206, 207, 209, 216, 217, and 219). The window units contain spacer frames (203, as shown in the figure on the left) and (213, as shown in the figure on the right). The spacer frame can be up to 7 mm thick. It has a perforation on the plane facing the inter-glass space filled with an inert gas inside the chamber, and it contains a moisture-absorbing molecular sieve.

The spacer frame (203, 213) was designed to seal the chamber and shape the double-glazed window. The spacer frame is bonded to each of the panes with a primary adhesion using a butyl sealant, forming a layer (204, 214), wherein the thickness of the butyl sealant layer is no more than 0.25 mm on each side. The primary adhesion step requires an application spacer frame at all points of contact with the window unit and around the perimeter of the double-glazed window where it touches the spacer.

To completely seal the two chambers, a secondary adhesion using a common hardening sealant is made (205, as shown in the figure on the left) and (215, as shown in the figure on the right). Glue or a well-known adhesive is applied as the secondary sealant at the ends of the double-glazed window along the parameter of the top and bottom edges of the double-glazed window forming a secondary sealant layer. The thickness of the secondary sealant layer when it is applied is at least 4 mm.

The temperature of the gas in the chamber between the glass sheets can vary significantly between the time of manufacture and installation. And, the temperature of the gas in the chamber can vary when the window unit is installed. A shift of as much as 40 °C or more (compared between the ambient temperature at the factory to the construction or installation site outside) has been observed, especially when the window is taken from a production facility where it was manufactured at about +20 °C and then installed outside at −20 °C or lower temperature conditions.

FIGS. 1 and 2 show deformations when the window units undergo significant temperature and pressure changes during operation. The image on the left in FIG. 1 (and in FIG. 2) depicts lensing distortion or deformation in glass sheets (101, 102) when the double-glazed window is compressed under the influence of internal negative pressure and the gas inside the double-glazed window is cooled. The temperature of the air or inert gas that fills a chamber (108) between the two sheets of glass in the double-glazed window is lower than the temperature in the chamber of the double-glazed window during its manufacture under ambient temperature conditions.

In the window unit on the right of FIG. 1 (and in FIG. 2), the glass panes are bulging due to the influence of internal positive pressure when the gas inside the insulating glass unit is heated. The temperature of the air or inert gas in the chamber (118) between the two panes of glass in the double-glazed window is higher than the temperature in the insulating glass unit during its manufacture under ambient temperature conditions.

The lensing distortion or deformation effect on the glass sheet becomes visible to the naked eye when it begins to deflect and distort when glass is deformed by 10 mm or more, or at least 1/250 of the length along the short side and 1/350 of the length along the long side of a rectangular double-glazed window with dimensions of 2500×3500 mm. Thus, it should not exceed 1/250 on the short side or 1/350 on the long side of the double-glazed window when exposed to short-term or long-term loads.

Compared to the conventional double-glazed window, the inventive double-glazed window of increased strength and stiffness showed no observable or measurable seal leaks in the chamber after installation and use. The inventive window unit exhibited no visible deformations compared to conventional single-chambered and double-chambered window units having all the same parameters, same glass formulation, same thickness and with the same inter-pane distances.

The inventive composite spacer with rigid profile can be provided in mixed fiber and/or resin compositions selected from the group consisting of, glass fiber filled thermoplastic extrusions, glass fiber pultrusions, glass fiber thermoplastic extrusions reinforced with thermoplastic pultruded strips, oriented thermoplastic extrusions, and structural thermoplastic foam extrusions. Wherein the rigid profile can be a pultruded fiberglass profile.

According to one aspect of the invention, the composite spacer with rigid profile should have a heat conductivity that is low, near or at the thermal conductivity of fiberglass, which is 0.3 W/m °C. The glass fiber content of the composite spacer with rigid profile can be as high as 80%. As a result, the material is very stiff and rigid with the coefficient of thermal expansion being very similar to that of glass.

To form a highly adhesive layer between the composite spacer with rigid profile and the glass, the highly adhesive sealant must exhibit the following physical and mechanical characteristics:
a) Reduced modulus of elasticity E of the composite spacer with rigid profile is 4.0×10⁷ N/m² or more.
b) Reduced modulus of elasticity E of the composite spacer with rigid profile is 9.0×10⁹ N/m² or less.
c) Adhesive Tensile Strength of more than 1.5×10⁶ N/m².
d) A Poisson's coefficient ratio of 0.2-0.4.

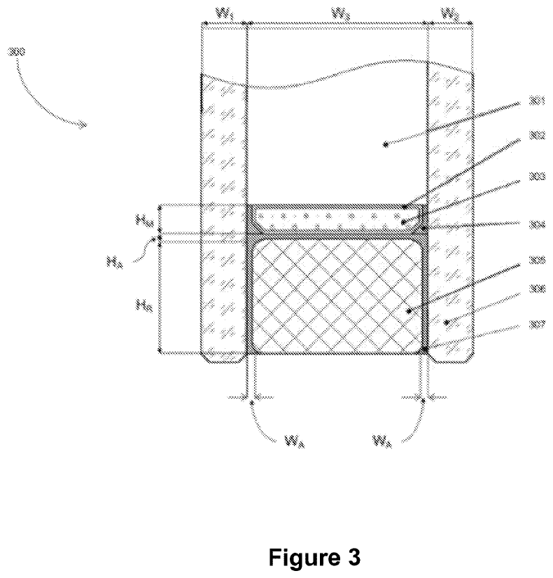

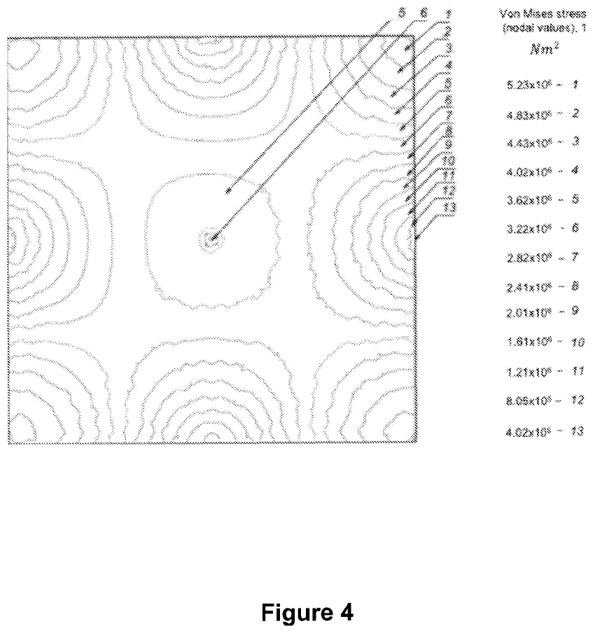

FIG. 3 is a depiction of the double-glazed single chamber window (300) unit having the inventive composite spacer with rigid profile. The window unit has two sheets of glass (306) with a width W₁ and a width W₂, both of which are 4.0 mm or more. The internal space between two sheets of glass is marked with the dimension W₃, which is the distance measured on the inside between the two sheets of glass. The width of the chamber is 14 mm or more.

The double-glazed window assembly further comprises a distance frame (302) with a height (H_{M}) of 7.0 mm or less, having a perforation on the plane facing the chamber space (301). The chamber space is filled with dried air or an inert gas, e.g. argon or krypton. The distance frame (302) completely surrounds a moisture-absorbing molecular sieve (303). The distance frame (302) is glued to each of the panes (306) with a first adhesive comprising a first sealant forming a layer (304), wherein the thickness of the first sealant layer is no more than 0.25 mm on each side around the entire perimeter of the glass unit.

The composite spacer with rigid profile comprises a reinforcing pultrusion beam (305) and a second sealant forming a highly adhesive layer (307) around the entire perimeter of the spacer where it attaches to the panes of glass in the window unit. The height (H_{A}) of the adhesive layer (307) is 5 mm or less, and more preferably 3.0 mm or less, and the width (W_{A}) of the adhesive layer (307) is 2.0 mm or less.

The pultrusion spacer depth is a function of width, D₃=W₃−2×W_{A}. The pultrusion spacer height=H_{R}. The optimum height to depth ratio H_{R}/D₃ is 0.8 or more. Thus:

When W₃=14 mm, then D₃=11 mm, H_{R}=9 mm.

When W₃=16 mm, then D₃=13 mm, H_{R}=11 mm.

When W₃=18 mm, then D₃=15 mm, H_{R}=12 mm.

When W₃=20 mm, then D₃=17 mm, H_{R}=14 mm.

When W₃=22 mm, then D₃=19 mm, H_{R}=16 mm.

When W₃=24 mm, then D₃=21 mm, H_{R}=18 mm.

FIG. 4 depicts the Von Mises equivalent stresses on a simulated double-glazed windowpane of the prior art under a 400 Pa load showing a distribution of regions of high and low stresses. The insulating glass unit has a dimension of 2×2 m in size and a formula 8-18-8. The window unit comprises a conventional composite spacer exhibiting a typical reduced modulus of elasticity of the spacer E=1×10⁶ N/m². It can be seen here that the zones of maximum stress are concentrated in the corners of the double-glazed window and occupy a small area, and therefore they are large.

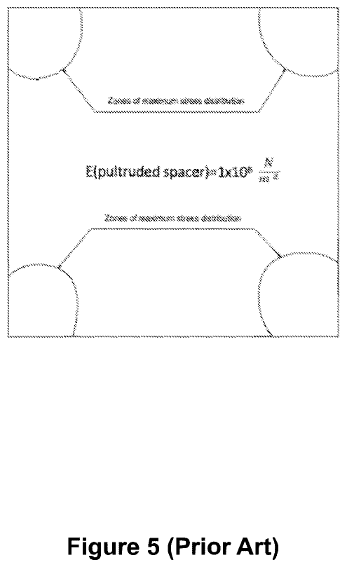

FIG. 5 is a simplified depiction of FIG. 4. FIG. 5a shows the zones of maximum stress distribution found in a conventional double-glazed window unit are concentrated at the corners of the unit. The typical conventional double-glazed windows utilize composite spacers having a reduced modulus of elasticity of E=1.0×10⁶ N/m². Lacking adequate rigidity makes the entire window unit structure susceptible to degradation of the seal in the chamber, and it contributes to the bulging and/or collapsing of the window unit due to the limitations of the single low rigidity spacer.

By using our inventive composite spacer with the rigid profile having much higher reduced modulus of elasticity, E, we have achieved much greater rigidity and bearing capacity without using aluminum framing or heavier glass panes. The inventive composite rigid spacer may be used in addition to the conventional spacer or it can be used by itself.

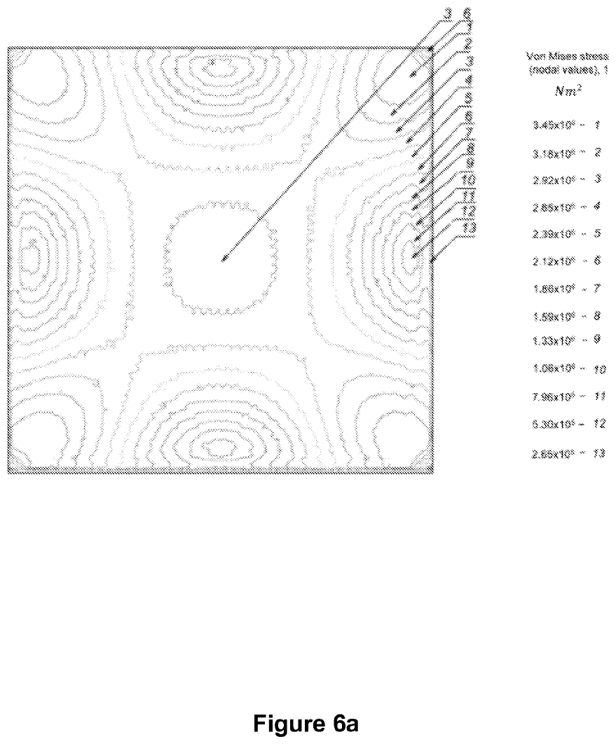

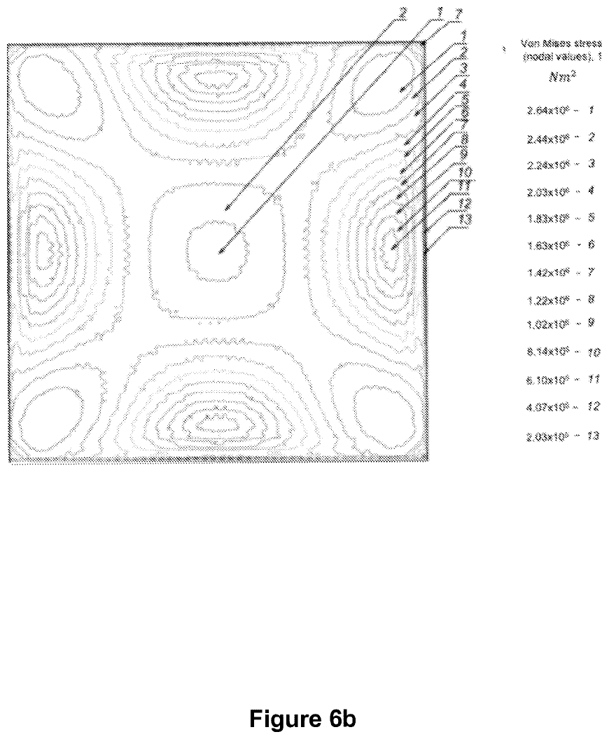

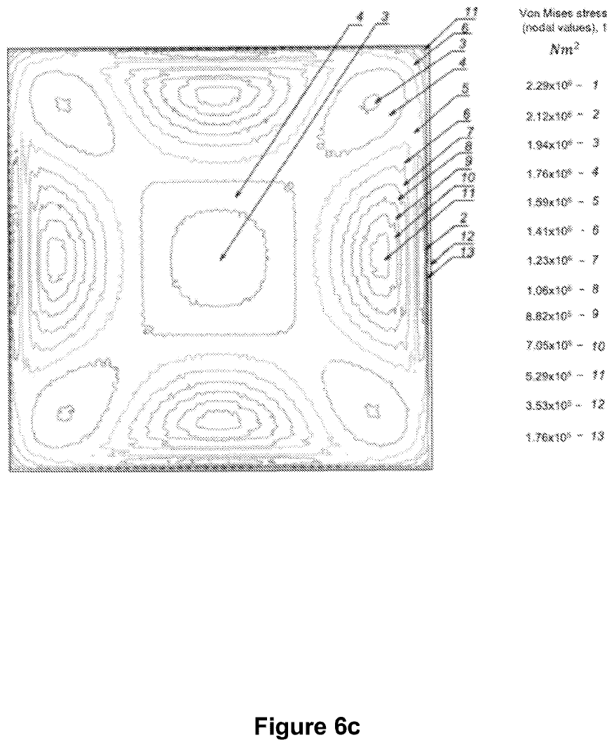

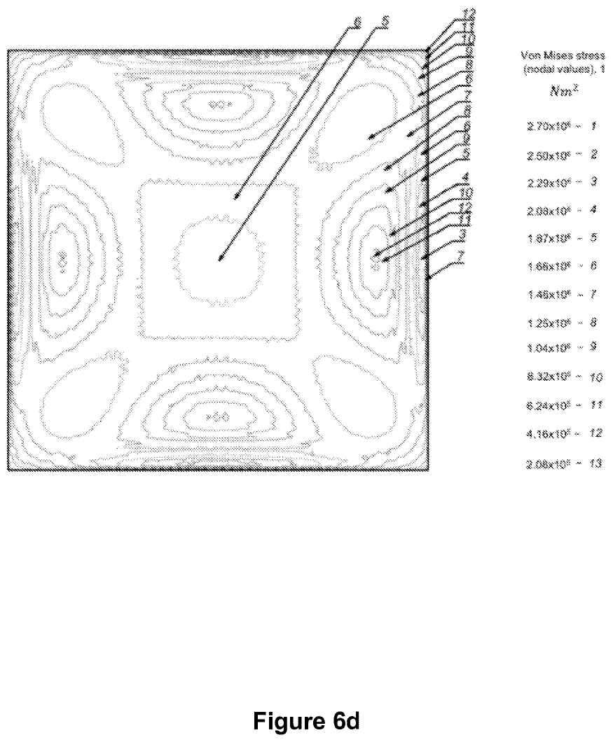

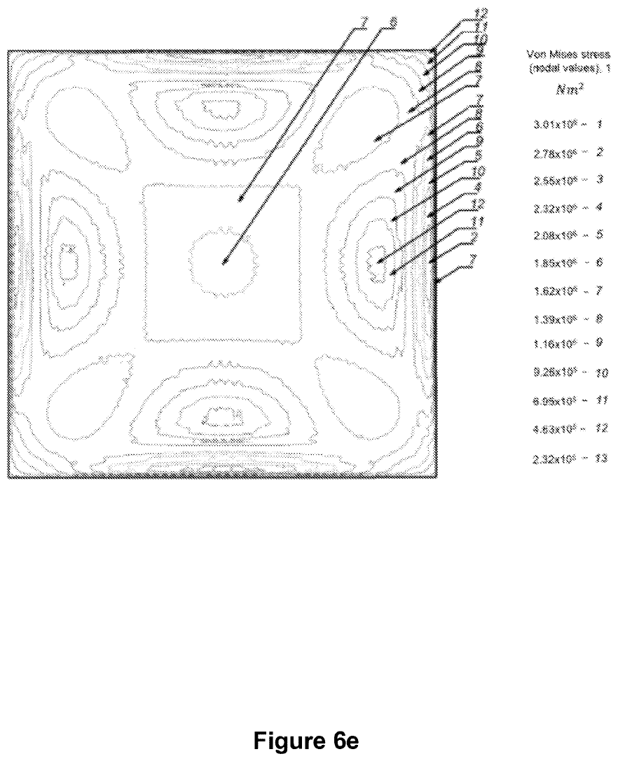

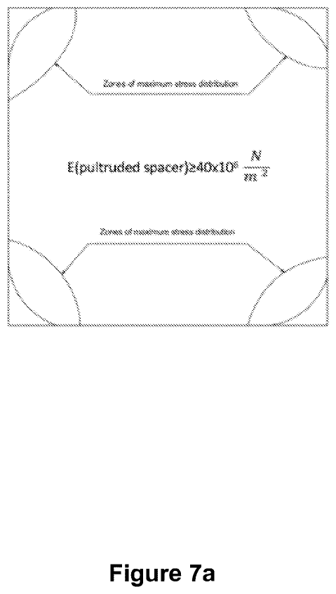

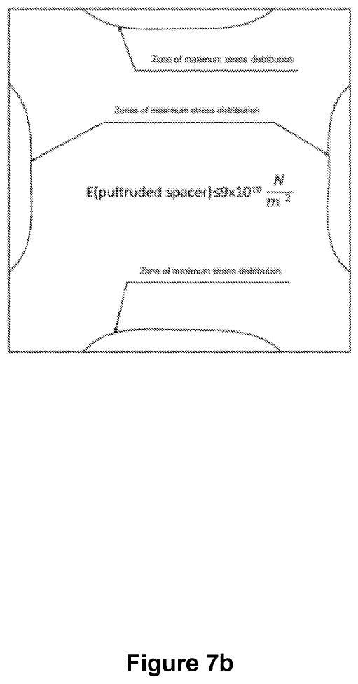

FIGS. 6a-6e depict a shifting of zones of high and low stresses under a pressure of 400 Pa in an inventive double-glazed window with increased strength and stiffness. The window has a dimension of 2×2 m in size and a formula 8-18-8. The window comprises the novel composite spacer with the pultruded fiberglass profile according to the instant invention exhibiting a much higher reduced modulus of elasticity of from 40×10⁶ N/m² to 9,000×10⁶ N/m² (or 4.0×10⁷ N/m² to 9.0×10⁹ N/m²). The inventive composite spacer with rigid profile exhibits 40 to 9,000 times greater reduced modulus of elasticity than that of the conventional distance spacer.

FIG. 6a shows the pattern of stress distribution with the reduced modulus of elasticity of the composite spacer equal to 40×10⁶ N/m², a lower boundary value of the modulus at which a double-glazed window can already be considered a double-glazed window of increased strength. It can be seen here that the zones of maximum stresses are already moving away from the corners of the double-glazed window and occupy larger areas than in FIG. 4, as a result of which the magnitude of the maximum stresses decreased.

FIG. 6b shows the pattern of stress distribution with the reduced modulus of elasticity of the composite spacer equal to 1.0×10⁸ N/m². It represents the minimum value of the modulus at which a double-glazed window of increased strength with such a reduced modulus of elasticity can already be used in practice. From the figure, it can be seen that the zones of maximum stresses have already completely moved away from the corners in the double-glazed windows and occupied areas even larger than in FIG. 6a, as a result of which the maximum stresses decreased even more.

FIG. 6c shows the pattern of stress distribution with the reduced modulus of elasticity of the composite spacer equal to 2.5×10⁸ N/m². It represents the minimum optimal value of the modulus at which minimum stresses and small displacements are achieved in an increased-strength double-glazed window. From the figure, it can be seen that the zones of maximum stresses are already located along the sides of the double-glazed window and occupied areas that are already smaller than in FIG. 6b, however, the values of the maximum stresses have significantly decreased.

FIG. 6d shows the pattern of stress distribution with the reduced modulus of elasticity of the composite spacer equal to 5.0×10⁸ N/m². It represents the optimal value of the modulus, at which, with increasing maximum stresses, the displacements in the double-glazed window still significantly decrease. From the figure, it can be seen that the zones of maximum stresses are located along the sides of the double-glazed window and occupy even smaller areas than in FIG. 6c, and the magnitude of the maximum stresses has already increased.

FIG. 6e shows the pattern of stress distribution with the reduced modulus of elasticity of the composite spacer equal to 1.0×10⁹ N/m². It represents the maximum value of the modulus at which, with an increase in maximum stresses, the displacements in the double-glazed window practically do not decrease. From the figure, it can be seen that the zones of maximum stresses have gathered near the centers sides of the double-glazed window and occupied areas of very small sizes, and the magnitude of the maximum stresses increased significantly than in FIG. 6c.

The novel composite spacer with rigid profile enables redistributing the stress regions away from the corners and towards the sides of the unit thereby significantly reducing the negative load impact on the corners. And, the novel composite spacer with rigid profile allows stretching and expanding the areas of maximum stresses in the unit thereby significantly improving load bearing capacity of the unit. Unexpectedly, we discovered that by controlling the physical dimensions of the composite spacer with rigid profile, its height, depth and length, the strength and stiffness of the window unit can be further optimized, and the stress zone distribution can be controlled. The zones of distribution of the stresses can be controlled by shifting the stresses completely away from the corners of the window unit.

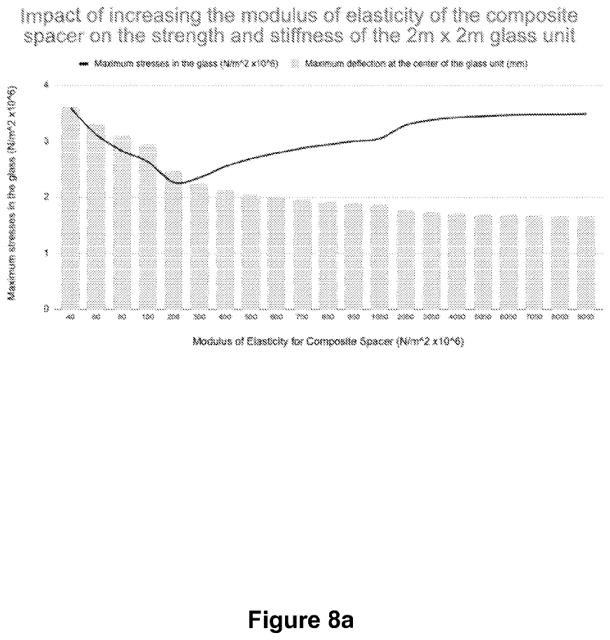

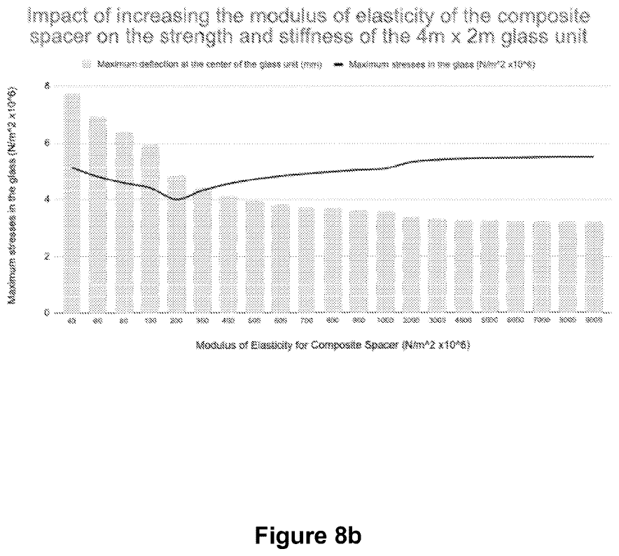

Both, the diagrams of the dependences of the maximum stresses and displacements on the value of the reduced modulus of elasticity of the composite distance frame as shown in FIGS. 8a and 8b, and the patterns of stress distribution as shown in FIGS. 4 and 6a-e, describe the trend in the change in mechanical properties double-glazed windows of increased strength and rigidity. These enable to select the optimal range of mechanical properties of double-glazed windows of increased strength and rigidity.

### Working Examples

A double-glazed window comprising an insulating glass unit was made with the formula 8-18-6, dimensions 2×2 m, and having a weight of 140 kg. This insulating glass unit contained a composite spacer including a pultrusion beam or bar consisting of 80% glass filaments bonded with epoxy resin. The pultrusion beam or bar has a coefficient of linear expansion that is equal to or near the coefficient of linear expansion of glass.

The window was assembled under conditions such that the glass unit originally exhibited an internal temperature of +20 °C (ambient temperature). The double-glazed unit was then exposed to outside temperature of −20 °C.

We measured the temperature difference performance of the unit having been exposed to an overall temperature difference of 40 °C. The glass unit comprising the rigid spacer changed shape in unison such that the properties of the overall assembly remained unchanged, and thus we observed no seal leakages, a marked improvement in rigidity and strength, and an increase in bearing capacity.

To get the same results from a conventional assembly, we had to use a much heavier 10-18-8 double-glazed unit weighing 180 kg with reinforced transoms. As can be seen in FIG. 4 depicting a typical stress load distribution of the double-glazed glass unit shows much higher stress loads developing in the corners of the unit leading to a decrease in strength and rigidity of the overall double-glazed unit.

As can be seen in FIGS. 6a-e depicting stress load distribution in the inventive frameless assembly, wherein the stress loads have been shifted from the corners to a more central location improving strength and rigidity.

Moreover, when compared to the typical double-glazed unit of the prior art, the glass assembly comprising 10-18-8 double-glazed unit with an aluminum frame, but without the rigid spacer, developed seal leakages leading to significant weakening in rigidity, strength, bearing capacity and lensing distortions as were observed in the glass unit of the prior art.

Further, the inventive frameless assembly has been exposed to changes in temperature, wind and weather conditions, but no leaks between glass panels were observed. However, in the typical glass plus frame structure of the prior art, continuous exposure to weather elements led to a significant loss in rigidity and strength. A noticeable appearance deterioration and increased lensing distortions in the entire facade of a building was observed.

Table 1 below shows test results of the analysis for the static strength of double-glazed 2 m×2 m windows, having 8 mm glass thickness and 18 mm gas chamber width, fixed on all four sides having a formula 8-18-8 under the influence of a wind pressure of 400 N/m² (400 Pa).

| Composite | Reduced modulus of | Maximum | Maximum | |
|---|---|---|---|---|
| spacer with rigid | elasticity of the | deflection at the | stresses in | |
| profile depth | composite spacer with an | center of the | the glass | |
| (mm) | adhesive (×10⁶ N/m²) | glass unit (mm) | (×10⁶ N/m²) | Comments |
| 7 | 1 | 4.95 | 5.23 | Conventional Unit |
| 15 | 40 | 3.60 | 3.45 | Inventive Unit |
| 15 | 60 | 3.30 | 3.12 | Inventive Unit |
| 15 | 80 | 3.08 | 2.83 | Inventive Unit |
| 15 | 100 | 2.92 | 2.64 | Inventive Unit |
| 15 | 200 | 2.46 | 2.27 | Inventive Unit |
| 15 | 300 | 2.24 | 2.35 | Inventive Unit |
| 15 | 400 | 2.12 | 2.55 | Inventive Unit |
| 15 | 500 | 2.04 | 2.70 | Inventive Unit |
| 15 | 600 | 1.98 | 2.79 | Inventive Unit |
| 15 | 700 | 1.94 | 2.88 | Inventive Unit |
| 15 | 800 | 1.90 | 2.94 | Inventive Unit |
| 15 | 900 | 1.88 | 3.00 | Inventive Unit |
| 15 | 1000 | 1.85 | 3.01 | Inventive Unit |
| 15 | 2000 | 1.75 | 3.29 | Inventive Unit |
| 15 | 3000 | 1.71 | 3.38 | Inventive Unit |
| 15 | 4000 | 1.69 | 3.43 | Inventive Unit |
| 15 | 5000 | 1.68 | 3.45 | Inventive Unit |
| 15 | 6000 | 1.67 | 3.47 | Inventive Unit |
| 15 | 7000 | 1.66 | 3.48 | Inventive Unit |
| 15 | 8000 | 1.65 | 3.48 | Inventive Unit |
| 15 | 9000 | 1.65 | 3.49 | Inventive Unit |

Table 2 below shows test results of the analysis for the static strength of double-glazed 4 m×2 m windows, having 8 mm glass thickness, fixed on four sides having a formula (8-18-8) under the influence of a wind pressure of 400 N/m².

| Composite | Reduced modulus of | Maximum | Maximum | |
|---|---|---|---|---|
| spacer with rigid | elasticity of the | deflection at the | stresses in | |
| profile depth | composite spacer with an | center of the | the glass | |
| (mm) | adhesive (×10⁶ N/m²) | glass unit (mm) | (×10⁶ N/m²) | Comments |
| 7 | 1 | 11.3 | 7.90 | Conventional Unit |
| 15 | 40 | 7.75 | 5.12 | Inventive Unit |
| 15 | 60 | 6.93 | 4.80 | Inventive Unit |
| 15 | 80 | 6.36 | 4.58 | Inventive Unit |
| 15 | 100 | 5.94 | 4.41 | Inventive Unit |
| 15 | 200 | 4.84 | 4.00 | Inventive Unit |
| 15 | 300 | 4.36 | 4.32 | Inventive Unit |
| 15 | 400 | 4.1 | 4.55 | Inventive Unit |
| 15 | 500 | 3.93 | 4.71 | Inventive Unit |
| 15 | 600 | 3.81 | 4.83 | Inventive Unit |
| 15 | 700 | 3.72 | 4.91 | Inventive Unit |
| 15 | 800 | 3.66 | 4.98 | Inventive Unit |
| 15 | 900 | 3.6 | 5.04 | Inventive Unit |
| 15 | 1000 | 3.56 | 5.09 | Inventive Unit |
| 15 | 2000 | 3.36 | 5.32 | Inventive Unit |
| 15 | 3000 | 3.29 | 5.40 | Inventive Unit |
| 15 | 4000 | 3.25 | 5.44 | Inventive Unit |
| 15 | 5000 | 3.23 | 5.46 | Inventive Unit |
| 15 | 6000 | 3.21 | 5.47 | Inventive Unit |
| 15 | 7000 | 3.2 | 5.49 | Inventive Unit |
| 15 | 8000 | 3.19 | 5.50 | Inventive Unit |
| 15 | 9000 | 3.18 | 5.50 | Inventive Unit |

FIGS. 8a and 8b are representative graphs based on the data shown in Table 1 and Table 2 (above), respectively. The graphs depict a relationship between the maximum stresses (represented by a line) and maximum displacements of an insulating glass unit (represented by the columns) relative to the increases in the reduced modulus of elasticity of the inventive composite spacer with an adhesive providing a rigid profile.

As can be seen from FIGS. 8a and 8b, when the reduced modulus of elasticity of the rigid spacer is initially increased from 40×10⁶ N/m² to 200×10⁶ N/m² (defined herein as Zone 1), we observed a decrease in the maximum stresses in the corners of the glass sheets along with a decrease in the maximum deflection (caving or bulging) of the glass sheet at its center.

Then, when the reduced modulus of elasticity of the rigid spacer is further increased from 200×10⁶ N/m² to 1,000×10⁶ N/m² (defined herein as Zone 2), we observed an additional decrease in the maximum deflection seen in the panes of the double-glazed window, but it is not as intense as can be observed in Zone 1. In Zone 2, we further observed an increase in the maximum stresses in the glass of the double-glazed window.

Finally, when the reduced modulus of elasticity of the rigid spacer is increased above 1,000×10⁶ N/m² (defined herein as Zone 3) up to 9,000×10⁶ N/m², we observed a significant decrease in the maximum glass deflections. In addition, at the transition point from Zone 2 to Zone 3, there is a jump in the maximum stresses in the panes of the double-glazed window (can be seen in the black line). After the jump, we observed only a slight increase in the maximum stresses in the panes of the double-glazed window. In other words, when the modulus of elasticity of the composite spacer is increased above 1,000×10⁶ N/m² (represented by Zone 3), there is virtually no effect on reducing the maximum glass deflections in a double-glazed window and we observed no further improvement on the maximum stresses in the glasses of a double-glazed window.

According to one embodiment of the present invention, the preferred range of the reduced modulus of elasticity of the rigid spacer is from 200×10⁶ N/m² to 1,000×10⁶ N/m². Wherein, when the rigid spacer reduced modulus of elasticity is less than 200×10⁶ N/m², the double-glazed unit loses the ability to withstand heavy loads, and when the reduced modulus of elasticity is above 1,000×10⁶ N/m², there is plateauing of the maximum stresses and thus there is no further improvement that can be observed.

More preferably, in order for high-strength double-glazed windows to withstand heavy loads and exhibit low optical distortion, the reduced modulus of elasticity of the composite spacer with rigid profile is from 200×10⁶ N/m² to 500×10⁶ N/m². Most preferably, the reduced modulus of elasticity of the composite spacer with rigid profile is from 400×10⁶ N/m² to 500×10⁶ N/m², where the maximum displacement and maximum stresses have not yet diverged greatly.

1. A frameless double-glazed window assembly having low optical distortion, wherein the window assembly comprises:
one or more interconnected double-glazed units, wherein each unit comprises two glass sheets that are hermetically sealed and fixed relative to each other,
a composite spacer with a rigid profile having an internal reinforcing cross-section, wherein the composite spacer with the rigid profile exhibits a high reduced modulus of elasticity made to increase the strength of each window and the overall rigidity, and wherein,
the composite spacer with the rigid profile is affixed internally within the assembly to keep the assembly optimally sealed around the contour of the enclosing glass structure, and wherein,
the assembly is stackable and does not require any kind of structural framing or brackets.

2. The frameless double-glazed window assembly of claim 1, wherein the composite spacer comprises a pultrusion of fiberglass forming a pultruded profile, and wherein it exhibits a high reduced modulus of elasticity of 40×10⁶ N/m² or more.

3. The frameless double-glazed window assembly of claim 2, wherein the composite spacer with the pultruded profile exhibits a high reduced modulus of elasticity of between 40×10⁶ N/m² to 9,000×10⁶ N/m².

4. The frameless double-glazed window assembly of claim 3, wherein the composite spacer with the pultruded profile exhibits a high reduced modulus of elasticity of between 40×10⁶ N/m² to 1,000×10⁶ N/m².

5. The frameless double-glazed window assembly of claim 3, wherein the composite spacer with the pultruded profile exhibits a high reduced modulus of elasticity of between 200×10⁶ N/m² to 500×10⁶ N/m².

6. The frameless double-glazed window assembly of claim 3, wherein the composite spacer with the pultruded profile exhibits a high reduced modulus of elasticity of between 400×10⁶ N/m² to 500×10⁶ N/m².

7. The frameless double-glazed window assembly of claim 1, wherein the glass unit has a low optical distortion of maximum displacement of less than 1/350 on the long side of the glass and less than 1/250 on the short side of the glass.

8. The frameless double-glazed window assembly of claim 1, wherein the double-glazed unit exhibits a high resistance to heat of up to 120 °C and relative humidity of up to 100%.

9. The frameless double-glazed window assembly of claim 1, wherein the composite spacer with rigid profile exhibits thermal conductivity of up to 0.4 W/(m °C).

10. The frameless double-glazed window assembly of claim 1, wherein the double-glazed unit is hermetically sealed having a structure with an improved water tightness as measured according to EN 12208:1999 and EN 1027:2016.

11. The frameless double-glazed window assembly of claim 10, wherein the double-glazed unit has no condensate formation in the space between the panes.

12. The frameless double-glazed window assembly of claim 1, wherein the assembly does not require any kind of vertical and horizontal aluminum profile structural elements.

13. The frameless double-glazed window assembly of claim 1, wherein the shape of an internal reinforcing cross-section of the composite spacer with the rigid profile is one of square, rectangular, oval, round, trapezoidal, or tubular.

14. A frameless double-glazed window assembly having a lightweight, and low optical distortion, wherein each unit of the window assembly comprises at least two panes of glass, a chamber or cavity filling the space between the two panes of glass, and a rigid spacer composite having a high reduced modulus of elasticity of at least 40×10⁶ N/m² or more, hermetically sealing the chamber or cavity.

15. The frameless double-glazed window assembly of claim 13, wherein the chamber or cavity between the two panes of glass contains a gas that fills the chamber or cavity.

16. The frameless double-glazed window assembly of claim 13, wherein the gas that fills the chamber or cavity is dried air, or inert gas selected from the group consisting of: argon, krypton, and mixtures thereof.

17. The frameless double-glazed window assembly of claim 15, wherein the gas that fills the chamber or cavity is dried air.

18. The frameless double-glazed window assembly of claim 15, wherein the gas that fills the chamber or cavity is argon.

19. The frameless double-glazed window assembly of claim 15, wherein the composite spacer with rigid profile is resistant to adhesion to silicone seals.

20. The frameless double-glazed window assembly of claim 15, wherein the shape of an internal reinforcing cross-section of the composite spacer with rigid profile is one of square, rectangular, oval, round, trapezoidal, or tubular.
